(19) United States
(12) Patent Application Publication
(10) Pub. No.: US 2022/0182772 A1
(43) Pub. Date: Jun. 9, 2022

(54) AUDIO SYSTEM FOR ARTIFICIAL REALITY APPLICATIONS

(71) Applicant: Facebook Technologies, LLC, Menlo Park, CA (US)

(72) Inventors: Peter Harty Dodds, Seattle, WA (US); Nava K. Balsam, Woodinville, WA (US); Vamsi Krishna Ithapu, Kirkland, WA (US); William Owen Brimijoin, II, Kirkland, WA (US); Samuel Clapp, Seattle, WA (US); Christi Miller, Seattle, WA (US); Michaela Warnecke, Somerville, MA (US); Nils Thomas Fritiof Lunner, Redmond, WA (US); Paul Thomas Calamia, Redmond, WA (US); Morteza Khaleghimeybodi, Bothell, WA (US); Pablo Francisco Faundez Hoffmann, Kenmore, WA (US); Ravish Mehra, Seattle, WA (US); Salvael Ortega Estrada, Redmond, WA (US); Tetsuro Oishi, Bothell, WA (US)

(21) Appl. No.: 17/677,902

(22) Filed: Feb. 22, 2022

Related U.S. Application Data
(60) Provisional application No. 63/153,037, filed on Feb. 24, 2021.
(60) Provisional application No. 63/176,595, filed on Apr. 19, 2021.
(60) Provisional application No. 63/193,766, filed on May 27, 2021.
(60) Provisional application No. 63/220,395, filed on Jul. 9, 2021.
(60) Provisional application No. 63/223,488, filed on Jul. 19, 2021.

(51) Int. Cl. H04R 25/00; G06N 3/04

(52) U.S. Cl. CPC H04R 25/353; H04R 25/554; G06N 3/04

(57) ABSTRACT

Embodiments relate to an audio system for various artificial reality applications. The audio system performs large scale filter optimization for audio rendering, preserving spatial and intra-population characteristics using neural networks. Further, the audio system performs adaptive hearing enhancement-aware binaural rendering. The audio includes an in-ear device with an inertial measurement unit (IMU) and a camera. The camera captures image data of a local area, and the image data is used to correct for IMU drift. In some embodiments, the audio system calculates a transducer to ear response for an individual ear using an equalization prediction or acoustic simulation framework. Individual ear pressure fields as a function of frequency are generated. Frequency-dependent directivity patterns of the transducers are characterized in the free field. In some embodiments, the audio system includes a headset and one or more removable audio apparatuses for enhancing acoustic features of the headset.

### CROSS REFERENCE TO RELATED APPLICATIONS

This application claims a priority and benefit to U.S. Provisional Patent Application Ser. No. 63/153,037, filed Feb. 24, 2021, U.S. Provisional Patent Application Ser. No. 63/176,595, filed Apr. 19, 2021, U.S. Provisional Patent Application Ser. No. 63/193,766, filed May 27, 2021, U.S. Provisional Patent Application Ser. No. 63/220,395, filed Jul. 9, 2021, and U.S. Provisional Patent Application Ser. No. 63/223,488, filed Jul. 19, 2021, each of which is hereby incorporated by reference in its entirety.

### FIELD OF THE INVENTION

The present disclosure relates generally to processing of audio content, and specifically relates to an audio system for artificial reality applications.

### BACKGROUND

Conventional systems for approximating head-related transfer functions (HRTFs) deliver a broadband frequency response curve using a few parameters. These systems reduce the number of parameters to produce a single frequency curve and optimize a set of filters to meet a target frequency response. However, approximating the entire HRTF, which is a multi-valued function defined on a sphere, to a lower parameter space in a spatially consistent manner and that is consistent across HRTFs from individual users remain a challenge.

Conventional hearing aids utilize a wide variety of complex signal processing algorithms to increase the audibility and intelligibility of a signal of interest. These algorithms are non-linear and time varying, meaning the changes that the hearing aid would apply at any given time to generate the most audible/intelligible output signal for a given listener would be dependent on characteristics of an input signal, the listener's individual hearing loss profile, and a state of the hearing aid device. Most often, the hearing aid signal processing can be realized by applying frequency-specific gains and attenuations that adapt based on the characteristics of the input signal. To spatialize a signal using HRTF convolution, it is commonly assumed that the only change between the input signal and the signal at the listener's ear is transformation applied by the HRTF and that the transformation is constant regardless of the characteristics of the input signal. Because the hearing aid applies gains non-linearly and in time varying manner, applying the HRTF to a signal before the signal is passed through the hearing aid would alter the spectral characteristics of the HRTF and localization would be distorted. If the spatialization is applied after the hearing aid processing, the HRTF filtering can negatively affect the signal processing used to improve audibility/intelligibility for the person with hearing loss.

Inertial measurement units (IMUs) typically utilized in audio devices can suffer from drift errors. This is because, in order to determine a position of an associated audio device, an IMU continually double-integrates acceleration with respect to time. Thus, any measurement error is accumulated over time leading to a drift error.

Conventionally, the prediction of sound transmission between a near-field acoustic transducer and an ear typically approximates the transducer as a perfect omnidirectional point-like source (i.e., a monopole). While this approximation simplifies the prediction problem, the true directivity pattern (which is unknown) of the transducer introduces errors and consequently makes the prediction less accurate.

Open ear headphones generally have poorer audio performance than their closed ear counterparts.

### SUMMARY

Embodiments of the present disclosure relate to a method for generating parameterized head related transfer functions (HRTFs) for rendering audio content to different users. The method comprises: processing, for each of multiple HRTFs, a target HRTF and one or more context vectors using a neural network encoder to generate a representation of the target HRTF as a computed frequency response; determining, for each of the multiple HRTFs, a difference between a frequency response associated with the target HRTF and the computed frequency response; updating, for each of the multiple HRTFs, one or more weights in association with the neural network encoder based on the determined difference; and generating one or more audio signal filter parameters that optimize weights of the neural network encoder over the multiple target HRTFs.

Embodiments of the present disclosure further relate to a method for performing an adaptive hearing enhancement. The method comprises: applying a hearing aid processing to an audio signal to generate an altered signal; applying an adaptive filter to the altered signal to generate a filtered version of the altered signal; spatializing the altered signal using a fixed HRTF to generate a spatialized version of the altered signal; and combining the filtered version of the altered signal and the spatialized version of the altered signal to generate audio content for presentation to a user, the audio content comprising a spatialized aided version of the audio signal.

Embodiments of the present disclosure further relate to a method for individual transducer equalization that includes transducer directivity. The method comprises: describing a transducer of a headset using a plurality of elementary spherical harmonic (SH) sources; generating individual ear pressure fields as a function of frequency for each of the plurality of elementary SH sources using an acoustic simulator; determining a set of weights for the transducer on the headset, the set of weights including a respective weight for each of the plurality of SH sources; and determining an individual headset-to ear acoustic response using the set of weights and the individual ear pressure fields.

Embodiments of the present disclosure further relate to an in-ear device (IED) for presenting audio content to a user. The IED comprises a body configured to fit at least partially within an ear canal, an inertial measurement unit (IMU) within the body, the IMU configured to provide IMU data, a camera coupled to the body, the camera positioned to capture images outside of the ear canal, a controller, and a transducer within the body. The controller determines positions of the IED using the IMU data, the positions including a drift error, adjusts the positions to remove the drift error, the adjustment based in part on positions of the IED determined using the captured images, and generates audio content based in part on the adjusted positions. The transducer presents the audio content to the user of the IED

Embodiments of the present disclosure further relate to a system for enhancing acoustic properties of an audio system on a headset (i.e., eyewear device). The system comprises a headset including an audio system, the audio system including at least one audio port on a temple arm of the headset that is configured to present audio content to a user of the headset. The system further comprises an audio apparatus that is removably coupled to the temple arm, the audio apparatus including at least one control that affects audio performance of the system, wherein the audio apparatus functions to enhance at least one acoustic property of the headset.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of an audio system, in accordance with one or more embodiments.

FIG. 3 is a block diagram of a fitting architecture that may be implemented at an audio system for generating audio signal filter parameters, in accordance with one or more embodiments.

FIG. 4 is a block diagram of a hearing assistance device performing an adaptive hearing enhancement, in accordance with one or more embodiments.

FIG. 5 illustrates an example in-ear device, in accordance with one or more embodiments.

FIG. 6 is a graphical representation of a process for individual transducer equalization that includes information about transducer directivity, in accordance with one or more embodiments.

FIG. 7A illustrates an example audio apparatus that is removably coupled to the a temple arm of a headset, in accordance with one or more embodiments.

FIG. 7B illustrates an example side cross section of the audio apparatus in FIG. 7A, in accordance with one or more embodiments.

FIG. 8A illustrates an example audio apparatus that includes a plurality of physical vents and an adjustment mechanism, in accordance with one or more embodiments.

FIG. 8B illustrates an example audio apparatus that includes one or more external microphones, in accordance with one or more embodiments.

FIG. 8C illustrates an example pair of audio apparatuses coupled to each other via a head band, in accordance with one or more embodiments.

FIG. 9 illustrates an example audio apparatus for enhancing acoustic features of an audio system that partially encloses a user's ear, in accordance with one or more embodiments.

FIG. 10 is a flowchart illustrating a process for generating parameterized head related transfer functions for rendering audio content to users, in accordance with one or more embodiments.

FIG. 11 depicts a block diagram of a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to an audio system for various artificial reality applications. In some embodiments, the audio system performs large scale filter optimization for head related transfer function (HRTF) rendering, preserving spatial and intra-population characteristics using neural networks. In some embodiments, the audio system performns adaptive hearing enhancement-aware binaural rendering. In some embodiments, the audio includes an in-ear device (IED) The IED includes an inertial measurement unit (IMU) and a camera. The camera captures image data of a local area, and the image data is used to correct for IMU drift. In some embodiments, the audio system calculates a transducer to ear response for an individual ear using an equalization prediction or acoustic simulation framework. Individual ear pressure fields as a function of frequency are generated. Frequency-dependent directivity patterns of the transducers are characterized in the free field. In some embodiments, the audio system includes a headset and a removable accessory for each ear. The headset (eyeglasses form factor) include one or more speakers for each ear. The audio system presented herein may be integrated into, e.g., a headset, a watch, a mobile device, a tablet, etc.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

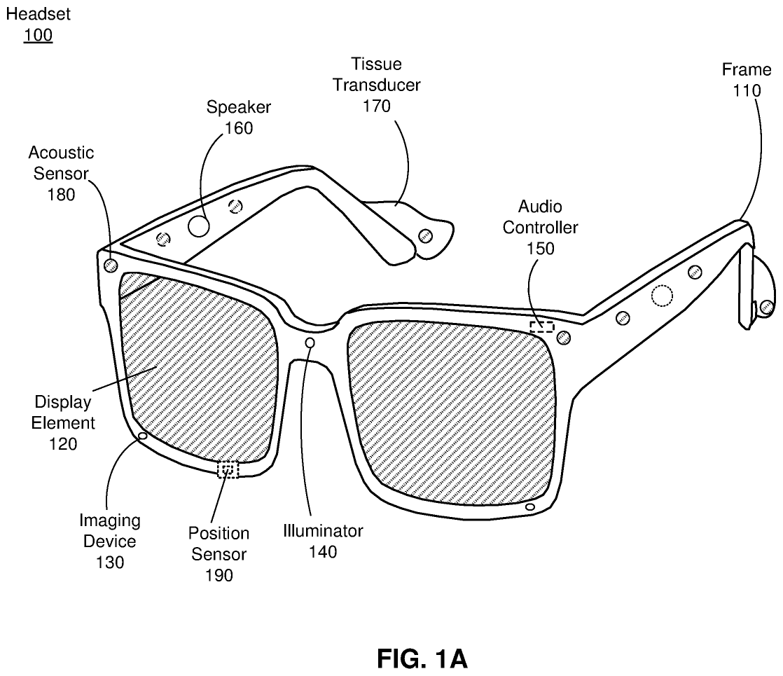

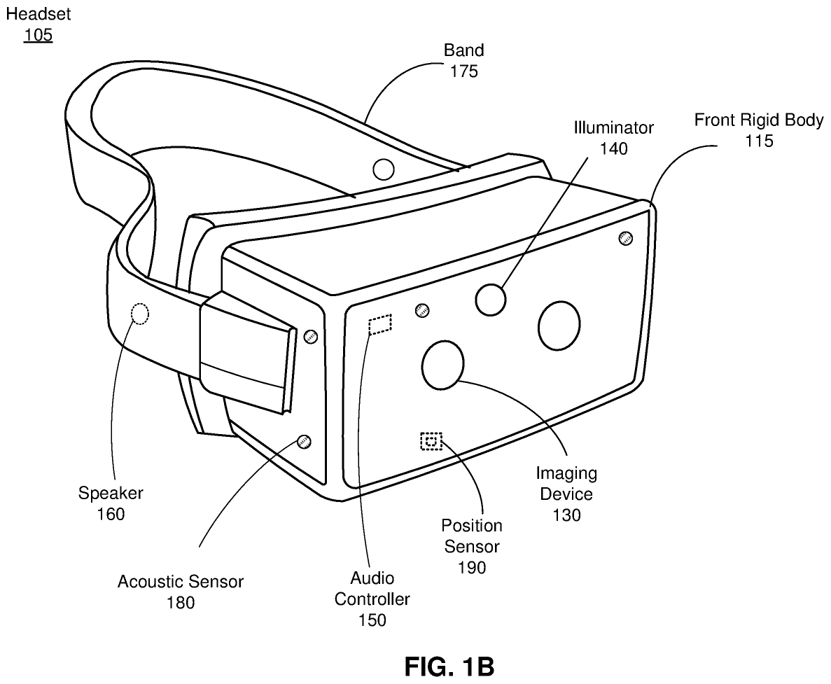

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, earpiece).

The one or more display elements 120 provide light to a user wearing the headset 100. As illustrated in FIG. 1A, the headset includes a display element 120 for each eye of a user. In some embodiments, a display element 120 generates image light that is provided to an eye box of the headset 100. The eye box is a location in space that an eye of the user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eye box of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eye box. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eye box. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A) and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the audio controller 150 may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. The tissue transducer 170 couples to the head of the user and directly vibrates tissue (e.g., bone or cartilage) of the user to generate sound. In accordance with embodiments of the present disclosure, the transducer array comprises two transducers (e.g.,, two speakers 160, two tissue transducers 170, or one speaker 160 and one tissue transducer 170), i.e., one transducer for each ear. The locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a non-transitory computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

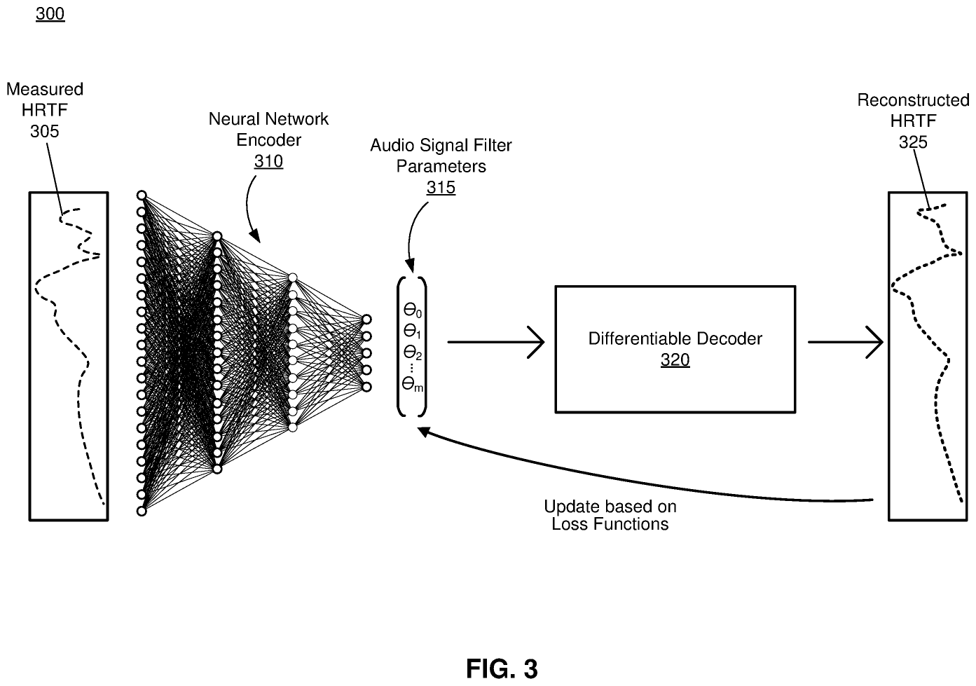

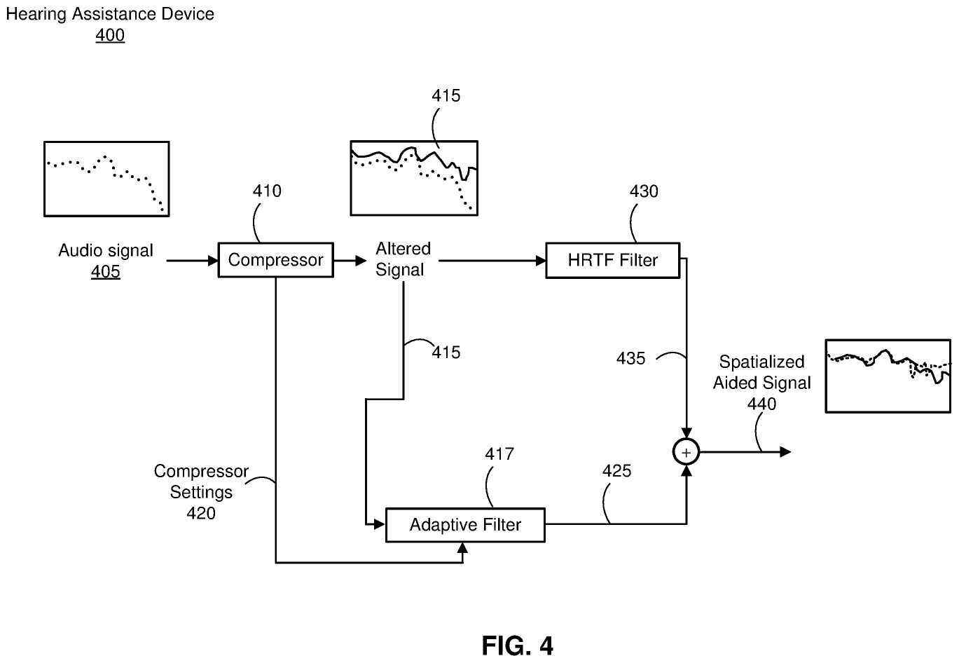

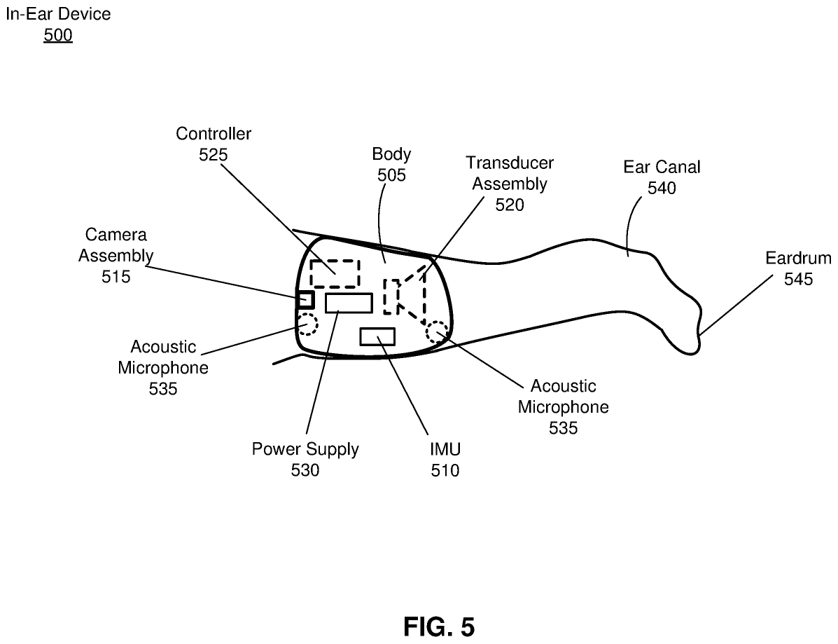

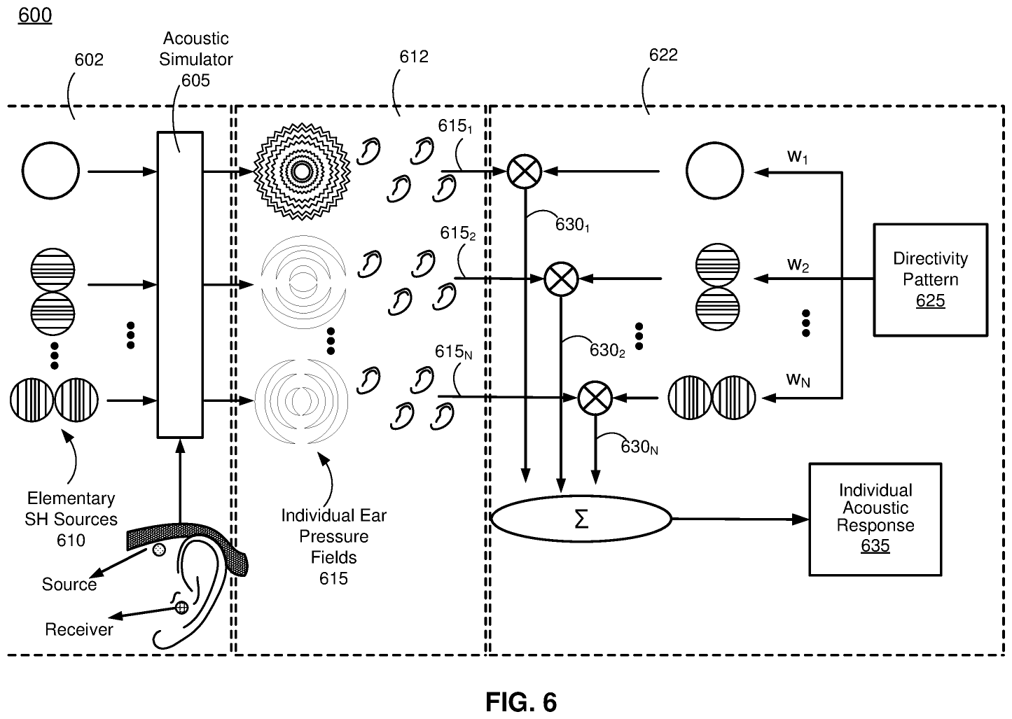

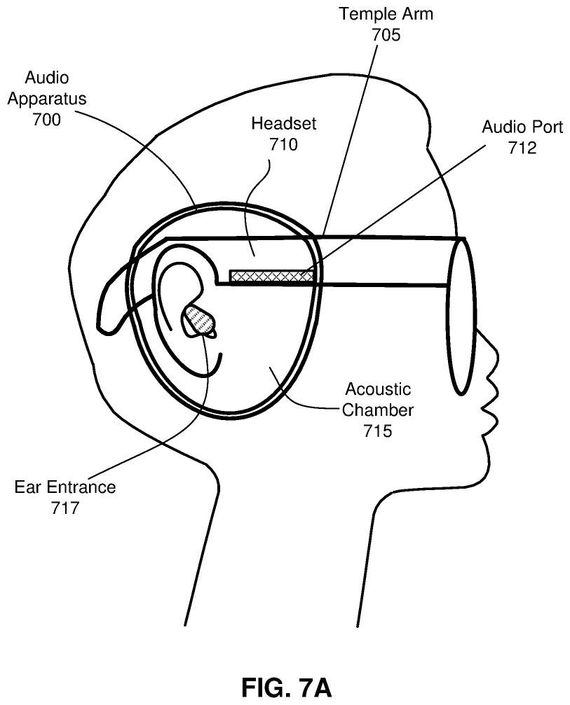

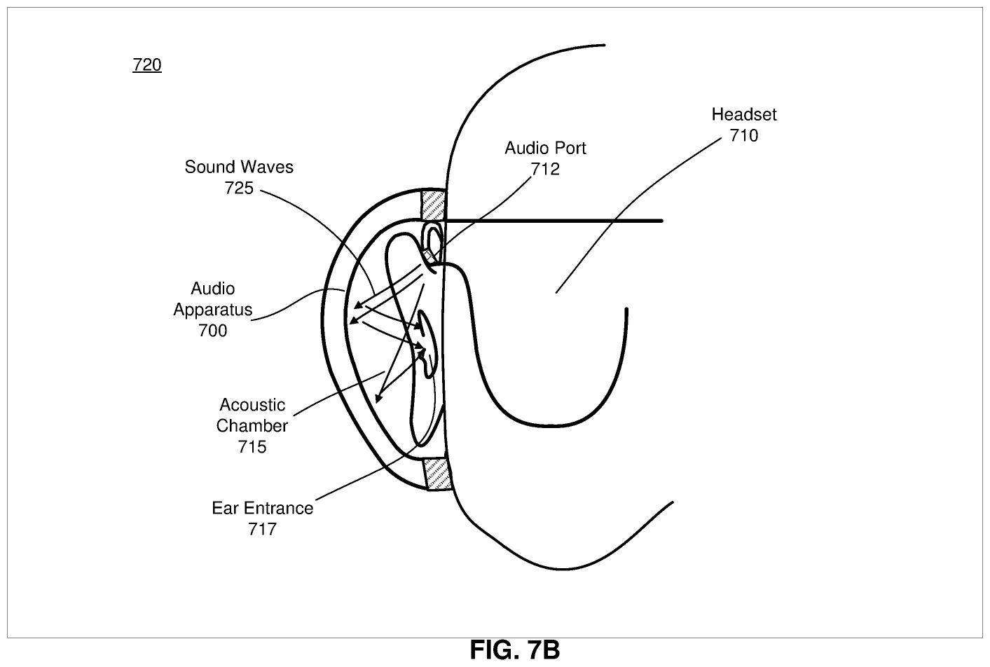

In some embodiments, the audio controller 150 generates parameterized HRTFs for rendering audio content to different users (e.g., as described below in conjunction with FIG. 3). In some other embodiments, the audio controller 150 performs an adaptive hearing enhancement (e.g., as described below in conjunction with FIG. 4). In some other embodiments, the audio controller 150 adjusts previously determined positions of an audio device to remove a drift error (e.g., as described below in conjunction with FIG. 5). In some other embodiments, the audio controller 150 performs individual transducer equalization that includes transducer directivity (e.g., as described below in conjunction with FIG. 6). In some other embodiments, the audio controller 150 facilitates enhancement of acoustic properties of the audio system 200 (e.g., as described below in conjunction with FIGS. 7A through 9).

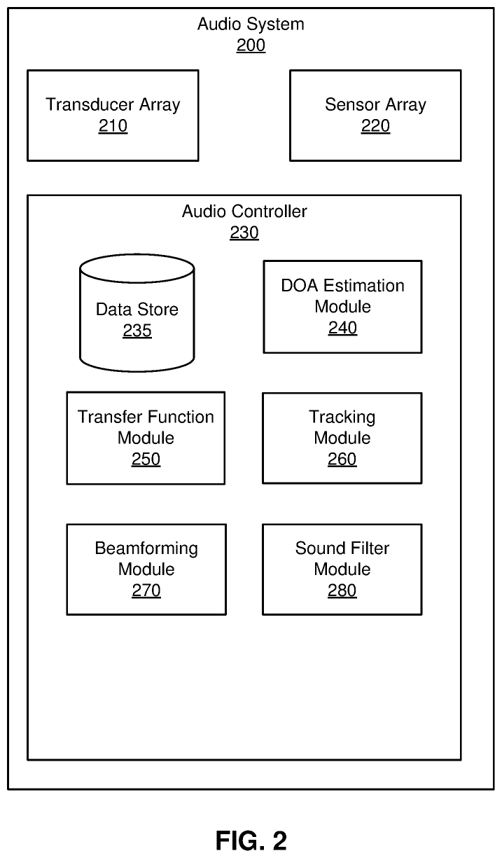

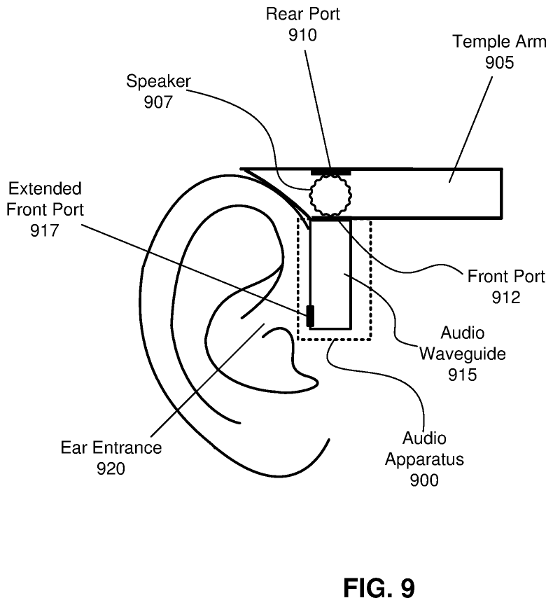

In some embodiments, the audio system is fully integrated into the headset 100. In some other embodiments, the audio system is distributed among multiple devices, such as between a computing device (e.g., smart phone or a console) and the headset 100. The computing device may be interfaced (e.g., via a wired or wireless connection) with the headset 100. In such cases, some of the processing steps presented herein may be performed at a portion of the audio system integrated into the computing device. For example, one or more functions of the audio controller 150 may be implemented at the computing device. More details about the structure and operations of the audio system are described in connection with FIG. 2 and FIG. 9.

The position sensor 190 generates one or more measurement signals in response to motion of the headset 100. The position sensor 190 may be located on a portion of the frame 110 of the headset 100. The position sensor 190 may include an IMU. Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

The audio system can use positional information describing the headset 100 (e.g., from the position sensor 190) to update virtual positions of sound sources so that the sound sources are positionally locked relative to the headset 100. In this case, when the user wearing the headset 100 turns their head, virtual positions of the virtual sources move with the head. Alternatively, virtual positions of the virtual sources are not locked relative to an orientation of the headset 100. In this case, when the user wearing the headset 100 turns their head, apparent virtual positions of the sound sources would not change.

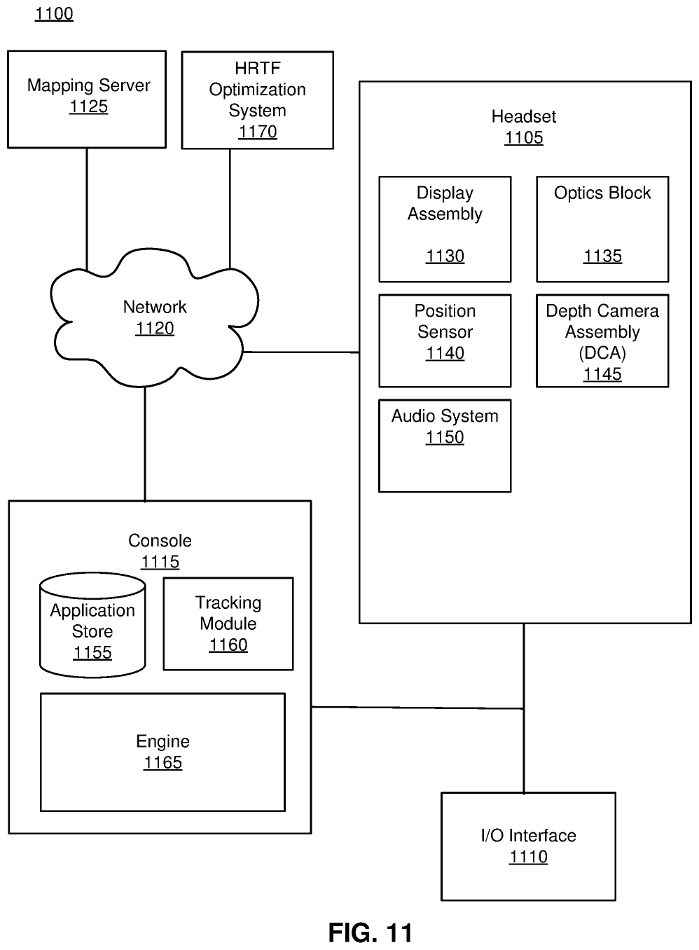

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA, and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 2 and FIG. 11.

FIG. 1B is a perspective view of a headset 105 implemented as a head-mounted display (HMD), in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to the front rigid body 115, or may be configured to be inserted within the ear canal of a user.

FIG. 2 is a block diagram of an audio system 200, in accordance with one or more embodiments. The audio system in FIG. 1A or FIG. 1B may be an embodiment of the audio system 200. The audio system 200 generates one or more acoustic transfer functions for a user. The audio system 200 may then use the one or more acoustic transfer functions to generate audio content for the user. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes a pair of transducers, i.e., one transducer for each ear. A transducer is a device that provides audio content. A transducer may be, e.g., a speaker (e.g., the speaker 160), a tissue transducer (e.g., the tissue transducer 170), some other device that provides audio content, or some combination thereof. A tissue transducer may be configured to function as a bone conduction transducer or a cartilage conduction transducer. The transducer array 210 may present audio content via air conduction (e.g., via one or two speakers), via bone conduction (via one or two bone conduction transducer), via cartilage conduction audio system (via one or two cartilage conduction transducers), or some combination thereof.

The bone conduction transducers generate acoustic pressure waves by vibrating bone/tissue in the user's head. A bone conduction transducer may be coupled to a portion of a headset and may be configured to be behind the auricle coupled to a portion of the user's skull. The bone conduction transducer receives vibration instructions from the audio controller 230 and vibrates a portion of the user's skull based on the received instructions. The vibrations from the bone conduction transducer generate a tissue-borne acoustic pressure wave that propagates toward the user's cochlea, bypassing the eardrum.

The cartilage conduction transducers generate acoustic pressure waves by vibrating one or more portions of the auricular cartilage of the ears of the user. A cartilage conduction transducer may be coupled to a portion of a headset and may be configured to be coupled to one or more portions of the auricular cartilage of the ear. For example, the cartilage conduction transducer may couple to the back of an auricle of the ear of the user. The cartilage conduction transducer may be located anywhere along the auricular cartilage around the outer ear (e.g., the pinna, the tragus, some other portion of the auricular cartilage, or some combination thereof). Vibrating the one or more portions of auricular cartilage may generate: airborne acoustic pressure waves outside the ear canal; tissue born acoustic pressure waves that cause some portions of the ear canal to vibrate thereby generating an airborne acoustic pressure wave within the ear canal; or some combination thereof. The generated airborne acoustic pressure waves propagate down the ear canal toward the ear drum.

The transducer array 210 generates audio content in accordance with instructions from the audio controller 230. In some embodiments, the audio content is spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable device (e.g., the headset 100 or the headset 105). In alternate embodiments, the transducer array 210 may be a pair of speakers that are separate from the wearable device (e.g., coupled to an external console).

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset (e.g., headset 100 and/or the headset 105), on a user (e.g., in an ear canal of the user), on a neckband, or some combination thereof. An acoustic sensor may be, e.g., a microphone, a vibration sensor, an accelerometer, or any combination thereof In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The audio controller 230 controls operation of the audio system 200. In the embodiment of FIG. 2, the audio controller 230 includes a data store 235, a DOA estimation module 240, a transfer function module 250, a tracking module 260, a beamforming module 270, and a sound filter module 280. The audio controller 230 may be located inside a headset, in some embodiments. Some embodiments of the audio controller 230 have different components than those described here. Similarly, functions can be distributed among the components in different manners than described here. For example, some functions of the audio controller 230 may be performed external to the headset. The user may opt in to allow the audio controller 230 to transmit data captured by the headset to systems external to the headset, and the user may select privacy settings controlling access to any such data.

In some embodiments, the audio controller 230 generates parameterized HRTFs for rendering audio content to different users (e.g., as described below in conjunction with FIG. 3). In some other embodiments, the audio controller 230 performs an adaptive hearing enhancement (e.g., as described below in conjunction with FIG. 4). In some other embodiments, the audio controller 230 adjusts previously determined positions of an audio device to remove a drift error (e.g., as described below in conjunction with FIG. 5). In some other embodiments, the audio controller 230 performs individual transducer equalization that includes transducer directivity (e.g., as described below in conjunction with FIG. 6). In some other embodiments, the audio controller 230 facilitates enhancement of acoustic properties of the audio system 200 (e.g., as described below in conjunction with FIGS. 7A through 9).

The data store 235 stores data for use by the audio system 200. Data in the data store 235 may include sounds recorded in the local area of the audio system 200, audio content, HRTFs, transfer functions for one or more sensors, array transfer functions (ATFs) for one or more of the acoustic sensors, sound source locations, virtual model of local area, direction of arrival estimates, sound filters, virtual positions of sound sources, multi-source audio signals, signals for transducers (e.g., speakers) for each ear, and other data relevant for use by the audio system 200, or any combination thereof. The data store 235 may be implemented as a non-transitory computer-readable storage medium.

The user may opt-in to allow the data store 235 to record data captured by the audio system 200. In some embodiments, the audio system 200 may employ always on recording, in which the audio system 200 records all sounds captured by the audio system 200 in order to improve the experience for the user. The user may opt in or opt out to allow or prevent the audio system 200 from recording, storing, or transmitting the recorded data to other entities.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 220 received the direct-path audio signal. The determined angle may then be used to identify the DOA for the received input signal. Other algorithms not listed above may also be used alone or in combination with the above algorithms to determine DOA.

In some embodiments, the DOA estimation module 240 may also determine the DOA with respect to an absolute position of the audio system 200 within the local area. The position of the sensor array 220 may be received from an external system (e.g., some other component of a headset, an artificial reality console, a mapping server, a position sensor (e.g., the position sensor 190, etc.). The external system may create a virtual model of the local area, in which the local area and the position of the audio system 200 are mapped. The received position information may include a location and/or an orientation of some or all of the audio system 200 (e.g., of the sensor array 220). The DOA estimation module 240 may update the estimated DOA based on the received position information.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be ATFs, HRTFs, other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. And collectively the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, the ATFs of the sensor array 220 are personalized for each user of the audio system 200.

In some embodiments, the transfer function module 250 determines one or more HRTFs for a user of the audio system 200. The HRTF characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 250 may determine HRTFs for the user using a calibration process. In some embodiments, the transfer function module 250 may provide information about the user to a remote system. The user may adjust privacy settings to allow or prevent the transfer function module 250 from providing the information about the user to any remote systems. The remote system determines a set of HRTFs that are customized to the user using, e.g., machine learning, and provides the customized set of HRTFs to the audio system 200.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond. The tracking module may compare the current DOA estimates with previous DOA estimates, and in response to a change in a DOA estimate for a sound source, the tracking module 260 may determine that the sound source moved. In some embodiments, the tracking module 260 may detect a change in location based on visual information received from the headset or some other external source. The tracking module 260 may track the movement of one or more sound sources over time. The tracking module 260 may store values for a number of sound sources and a location of each sound source at each point in time. In response to a change in a value of the number or locations of the sound sources, the tracking module 260 may determine that a sound source moved. The tracking module 260 may calculate an estimate of the localization variance. The localization variance may be used as a confidence level for each determination of a change in movement.

The beamforming module 270 is configured to process one or more ATFs to selectively emphasize sounds from sound sources within a certain area while de-emphasizing sounds from other areas. In analyzing sounds detected by the sensor array 220, the beamforming module 270 may combine information from different acoustic sensors to emphasize sound associated from a particular region of the local area while deemphasizing sound that is from outside of the region. The beamforming module 270 may isolate an audio signal associated with sound from a particular sound source from other sound sources in the local area based on, e.g., different DOA estimates from the DOA estimation module 240 and the tracking module 260. The beamforming module 270 may thus selectively analyze discrete sound sources in the local area. In some embodiments, the beamforming module 270 may enhance a signal from a sound source. For example, the beamforming module 270 may apply sound filters which eliminate signals above, below, or between certain frequencies. Signal enhancement acts to enhance sounds associated with a given identified sound source relative to other sounds detected by the sensor array 220.

The sound filter module 280 determines sound filters for the transducer array 210. In some embodiments, the sound filters cause the audio content to be spatialized, such that the audio content appears to originate from a target region. The sound filter module 280 may use HRTFs and/or acoustic parameters to generate the sound filters. The acoustic parameters describe acoustic properties of the local area. The acoustic parameters may include, e.g., a reverberation time, a reverberation level, a room impulse response, etc. In some embodiments, the sound filter module 280 calculates one or more of the acoustic parameters. In some embodiments, the sound filter module 280 requests the acoustic parameters from a mapping server (e.g., as described below with regard to FIG. 11).

The sound filter module 280 provides the sound filters to the transducer array 210. In some embodiments, the sound filters may cause positive or negative amplification of sounds as a function of frequency. In some embodiments, audio content presented by the transducer array 210 is multi-channel spatialized audio. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200.

### Large Scale Filter Optimization for Generalized HRTFs

Embodiments of the present disclosure may include or be implemented in conjunction with an audio system that provides spatialized audio content. The audio system may be part of a headset. In some embodiments, the headset may be an artificial reality headset (e.g., presents content in virtual reality, augmented reality, and/or mixed reality). The audio system may use the method provided in embodiments herein to render spatialized audio content to users through the headset. Spatialized audio content is audio content that appears to originate from a particular direction and/or target region (e.g., an object in the local area and/or a virtual object).

A HRTF is a multi-valued function on a sphere that is individualized to each user. A HRTF of a user may contain redundant information and/or patterns. Furthermore, HRTFs of multiple users may comprise similar functional information across these HRTFs. Therefore, it is possible to approximate the HRTFs of multiple users using low-complexity signal processing tools such as infinite impulse response (IIR) filters and/or biquad filters.

In performing filter optimizations for HRTFs, a conventional approach would be to initialize a set of filter parameters (e.g., a mean of all desired HRTFs to be fit), and then individually optimize the IIR filters to match the measured HRTFs at each position in the dataset. However, while HRTFs are measured at finite locations in space, the measured HRTFs are continuous spherical functions with smoothly varying feature values. Therefore, optimizing the IIR filters to discrete locations in space may result in a loss of continuity and smoothly varying feature values across the spherical space. Conventional optimizations can therefore create issues when utilizing parametric HRTF models for real-time rendering because the interpolation of filter parameters from one point in the spherical space to another point in spherical space may result in a parametric response that is not an approximation of the interpolation of the measured HRTF from one point to another on the sphere. Furthermore, HRTFs have measured features that are semantically similar between individual people. For example, a peak or a notch for two users may provide similar perceptual cues but may be located at different locations in frequency space and have different magnitudes.

Hence, while a sufficient number of cascaded IIR filters may be used to closely match a given frequency response, for an HRTF filter architecture to be generalizable, the filters used to approximate the HRTFs may need to behave in an analogous manner across space as well as across multiple users. Specifically, a given filter in this architecture may need to keep its basic identify/function across angles to be capable of changing smoothly across the spherical space and the filter may need to play a similar role in the HRTF of different individuals to be capable of changing smoothly across users.

Embodiments presented herein resolve these issues and reduce an entire HRTF to a lower parameter space in a spatially consistent manner and in a manner that is consistent across HRTFs from different users. The parameterized HRTFs may be then used to render spatialized audio content to different users through the headset.

Embodiments presented herein utilize neural networks to fit a large database of HRTFs with parametric filters in such a way that the filter parameters vary smoothly across space and behave analogously across different users. The fitting method relies on a neural network encoder, a differentiable decoder that utilizes digital signal processing solutions, and an optimization of weights of the neural network encoder using loss functions to generate a set of filters that fit across the database of HRTFs.

FIG. 3 is a block diagram of a fitting architecture 300 for generating audio signal filter parameters, in accordance with one or more embodiments. The fitting architecture 300 may be part of an audio system, e.g., part of the audio controller 230 of the audio system 200. The fitting architecture 300 may include a neural network encoder 310 and a differentiable decoder 320 coupled to the neural network encoder 310. In other embodiments not shown in FIG. 3 the fitting architecture 300 may include different and/or additional components. The fitting architecture 300 may receive a measured (or target) HRTF 305 from a data set of measured HRTFs in association with a set of context vectors. The context vectors may encode parameters such as: spatial location at which the HRTF is measured, anthropometric features values of an individual user, one or more other parameters, or combination thereof. The measured HRTF 305 along with the context vectors may be provided the to the neural network encoder 310.

The neural network encoder 310 may optimize (i.e., learn) weights associated with connections between nodes of a neural network associated with the neural network encoder 310. The neural network encoder 310 may be implemented as an encoder that includes a multi-layer fully connected neural network. The neural network encoder 310 may optimize the weights to generate a low dimensional representation of the measured HRTF 305. The low dimensional representation of the measured HRTF 305 may be treated as, e.g., a gain, center frequency, and Q factor of a set of biquad filters that are arranged in a cascade. The computed frequency response of the filter cascade may be represented as a set of audio signal filter parameters 315. The set of audio signal filter parameters 315 may be provided to the differentiable decoder 320 for further processing.

The differentiable decoder 320 may determine a difference between the computed frequency response of the filter cascade (i.e., represented with the audio signal filter parameters 315) and the original frequency response of the measured HRTF 305. The differentiable decoder 320 may generate a reconstructed HRTF 325 and determine a loss function by differentiating the reconstructed HRTF 325 from the measured HRTF 305. The differentiable decoder 320 may back propagate information about the determined loss function to the neural network encoder 310 for subsequent update of the weights of the neural network encoder 310.

This process of optimizing the weights of the neural network encoder 310 may be repeated over multiple measured (target) HRTFs sampled, e.g., from a large population of users and across multiple directions simultaneously to generate the set of audio signal filter parameters 315 that vary smoothly across space and consistently across users. Embodiments presented herein allow for efficient fitting of large databases of HRTFs in a manner that preserves spatial and intra-population characteristics. In addition, the presented optimization approach generalizes relatively well to unseen users. Furthermore, any number of additional context vectors may be appended to the frequency response to enable arbitrary levels of individualization.

### Adaptive Hearing Enhancement

When an audio signal passes through the digital signal processing operations of a hearing enhancement system, the audio signal may be transformed in non-linear and time varying ways. A spatialization method is presented herein in which the signal processing operations responsible for generating spatial cues are aware of the hearing enhancement signal processing that has been applied to the incoming input audio signal and adapts in real-time so that the audio signal of interest maintains audibility/intelligibility and is also correctly localizable to a person requiring a given level of hearing enhancement.

Because the hearing aid applies gains non-linearly and in time-varying manner, applying the HRTF to an audio signal before the audio signal is passed through the hearing aid would alter the spectral characteristics of the HRTF and localization would be distorted. If the spatialization is applied after the hearing aid processing, the HRTF filtering could negatively affect the signal processing used to improve audibility/intelligibility for the person with hearing loss. To overcome this, the spatialization of an audio signal is informed of the time-varying hearing aid processing and adapted so that spatial cues are preserved without detrimentally affecting hearing aid performance. A system and method is presented herein to manipulate an audio signal to provide binaural spatial cues that are not distorted by audibility and/or intelligibility enhancements.

Traditional binaural synthesis assumes the following form:

X(f)H(f)=Y(f), (1)

where X(f) is a frequency dependent audio signal of interest, H(f) is a frequency dependent HRTF, and Y(f) is a frequency dependent spatialized audio signal. It can be observed from Eq. 1 that the traditional binaural synthesis system is a linear time-invariant system in which the only dependence is on frequency. Applying hearing aid processing to an audio signal of interest would take the following form:

X(t, f)A(t, f)=Y′(t, f), (2)

where X(t, f) is a time-varying and frequency-dependent audio signal of interest, A(t, f) is a time-varying and frequency-dependent hearing aid processing, and Y′(t, f) is a time-varying and frequency-dependent enhanced output signal. It can be observed from Eq. 2 that the output signal Y′ is not only a function of frequency, but also of time (which may include the hearing aid state). The goal is that the enhanced signal Y′(t, f) is perceptually equivalent to the spatialized signal Y(f) from Eq. 1 for a listener with hearing loss. However, if the aided signal X(t, j) is directly spatialized, the cues would be distorted because X(t, f)A(t, f)≠X(f) and thus Eq. 1 cannot hold.

In order to correctly spatialize the aided signal X(t,j), a corresponding HRTF should be time-varying and adaptive to the hearing aid processing. This can be presented in the following manner:

X(t, f)A(t, f)H_{adapt}(t, f)=Y_{aided}(t, f), (4)

H_{fixed}(f)Γ(A(t, f))=H_{adapt}(t, f), (5)

where H_{adapt}(t, f) is a time-varying and frequency-varying HRTF, Y_{aided}(t, f) is a time-varying and frequency-dependent aided output audio signal, H_{fixed}(f) is an non-adaptive (fixed) HRTF component, and F(A(t, f)) is an adaptive filter that depends on the hearing aid processing.

It can be observed from Eq. 5 that H_{adapt}(t, fj) is a function of the non-adaptive HRTF, H_{fixed}(f), for a given location, as well as of the function F(A(t, f)) representing an adaptive filter that modifies the HRTF as a function of the hearing aid processing. It should be noted that the resulting spatialized signal is not the original spatialized signal, Y(f), but the aided signal Y_{aided}(t, f). This is because the original spatialized signal, Y(f), has no compensation for the listener's hearing loss profile. By imbuing Y_{aided}(t, f) with both the required signal processing for audibility/intelligibility as well as the hearing aid-informed spatialization, the resulting spatialized signal Y_{aided}(t, f) is perceptually equivalent to the original spatialized signal, Y(f), for a listener with a given hearing enhancement profile.

FIG. 4 is a block diagram of a hearing assistance device 400 performing an adaptive hearing enhancement (e.g., as defined by Eq. 4 and Eq. 5), in accordance with one or more embodiments. The hearing assistance device 400 may be part of an audio system, e.g., of the audio controller 230 of the audio system 200. The hearing assistance device 400 may be configured to provide frequency dependent signal processing based on an audiogram of a listener as well as the characteristics of the incoming audio signal of interest. The hearing assistance device 400 may include a compressor 410, an adaptive filter 417 coupled to the compressor 410 and a HRTF filter 430 coupled to the compressor 410. In other embodiments not shown in FIG. 4 the hearing assistance device 400 may include different and/or additional components.

The compressor 410 may apply the hearing aid processing to an audio signal 405 to generate an altered signal 415. The altered signal may include new frequency components introduced by the compressor 410. The hearing aid processing applied at the compressor 410 may comprise a time-varying and frequency-dependent processing. The hearing aid processing applied at the compressor 410 is represented with the function A(t, f) in Eq. 4 and Eq. 5.

The adaptive filter 417 may apply adaptive filtering to the altered signal 415 using information about compressor settings 420 to generate a filtered version of the altered signal 425. The adaptive filter 417 is a time-varying and frequency-dependent filter based on the compressor settings 420 and the altered signal 415. The adaptive filter 417 is represented with the function F(A(t, f)) in Eq. 5.

The HRTF filter 430 may spatialize the altered signal 415 using a fixed HRTF to generate a spatialized version of the altered signal 435. The fixed HRTF applied by the HRTF filter 430 may comprise a frequency-dependent HRTF. The fixed HRTF is represented with the function H_{fixed}(f) in Eq. 5. The filtered version of the altered signal 425 is combined with (e.g., added to) the spatialized version of the altered signal 435 to generate a spatialized aided signal 440 (Y_{aided}(t, f) (t in Eq. 4) for presentation to a listener with hearing loss. The spatialized aided signal 440 represents a spatialized aided version of the audio signal 405. The spatialized aided signal 440 preserves audibility/intelligibility but also provides correct localization cues.

### Head-Tracking Unit for In-Ear Device

Embodiments of the present disclosure are further related to an in-ear device (IED) (i.e., hearable device) that includes an IMU (i.e., head-tracking unit) and one or more outward-facing (i.e., world-facing) cameras. The IED may be configured to use images from the one or more outward facing cameras to correct for a drift error in head-tracking positions determined by the IMU.

FIG. 5 illustrates an example IED 500, in accordance with one or more embodiments. The IED 500 may include a body 505, one or more IMUS 510, a world-facing camera assembly 515, a transducer assembly 520, a controller 525, a power supply 530, and one or more acoustic microphones 535. In some embodiments, the IED 500 may also include, e.g., a transceiver for communicating with other devices (e.g., headset, smartphone, etc.). For example, the transceiver may be a Bluetooth unit integrated with the power supply 530. Alternatively, the transceiver may be a stand-alone device or integrated into some other component of the IED 500 (e.g., the controller 525).

The body 505 may be configured to hold the various components of the IED 500. The body 505 may be also configured to fit at least partially within an ear canal 540 of a user. The body 505 may be made out of, plastic, polymer, metal, some other material, or some combination thereof. In some embodiments, the body 505 is at least partially covered with a material (e.g., rubber) that helps create a seal with the ear canal 540. In other embodiments, an outer surface of the body 505 may directly contact an inner portion of the ear canal 540.

The IMU 510 is an electronic device that generates IMU data based on measurement signals received from one or more position sensors. The IMU 510 may be configured to fit within the body 505. A position sensor generates one or more measurement signals in response to a motion of the IED 500. Examples of position sensors include: one or more accelerometers, one or more gyroscopes, one or more magnetometers, another suitable type of sensor that detects motion, a type of sensor used for error correction of the IMU 510, or some combination thereof. The position sensors may be located external to the IMU 510, internal to the IMU 510, or some combination thereof.

The camera assembly 515 may be configured to capture one or more images of a local area of the user. The camera assembly 515 may include one or more cameras that are coupled to the body 505. The one or more cameras are outward facing (i.e., face towards the local area and not inside the ear canal 540) to capture images outside of the ear canal 540. A camera of the camera assembly 515 may be, e.g., a color camera, an infrared (IR) camera, or some combination thereof. The camera assembly 515 may have a frame rate that is slower than the data rate of the IMU 510. In some embodiments, the body 505 may also include a projector (not shown in FIG. 5) that is configured to illuminate the local area (e.g., with structured light and/or an IR flash). The projector may be integrated into the camera assembly 515.

The transducer assembly 520 may present audio in accordance with audio content provided by the controller 525. The transducer assembly 520 may be an embodiment of the transducer array 210. The transducer assembly 520 may be, e.g., a high-bandwidth audio transducer unit. The transducer assembly 520 may include one or more transducers within the body 505 that are configured to present audio to the user. A transducer of the transducer assembly 520 may be, e.g., a speaker positioned to output airborne pressure waves down the ear canal toward an eardrum 545 of the user, a tissue conduction transducer in contact with a tissue of the ear canal 540, a bone conduction transducer in contact with at least a portion of a head bone of the user, some other transducer, or some combination thereof.

The controller 525 may be configured to determine positions of the IED 500, e.g., using the IMU data obtained from the IMU 510. The determined positions may include a drift error. The controller 525 may use the images of the local area captured by the camera assembly 515 to determine the positions of the IED 500. In some embodiments, the controller 525 may determine depth information of the local area using the captured images and use the depth information to adjust positions of the IED 500 to correct for the drift error. For example, a projector and camera (e.g., integrated in the camera assembly 515) in conjunction with the controller 525 may function as a light detection and ranging (LIDAR) system to generate depth information for the local area. The controller 525 may then utilize the generated depth information to adjust the determined positions of the IED 500 and correct for the drift error.

It should be noted that the data rate of the IMU 510 may be faster than the data rate of the camera in the camera assembly 515. As such, the drift error may accumulate between image frames, and the controller 525 may be configured to correct for the drift error at each image frame. In this manner, the controller 525 may mitigate the drift error associated with the position of the IED 500. In some embodiments, the controller 525 may provide for simultaneous localization and mapping (SLAM) for a position of the IED 500 and updating of a model of the local area. The controller 525 may generate audio content based in part on the adjusted positions of the IED 500. For example, the controller 525 may generate one or more audio filters using the adjusted positions, and then apply the one or more audio filters to an audio signal to generate the audio content. The controller 525 may then provide the generated audio content to the transducer assembly 520 for presentation to the user.

### Individual Transducer Equalization Including Transducer Directivity

Being able to accurately characterize directivity of a transducer has important implications for the individual equalization of transducers on a headset to ensure high quality of audio reproduction. Embodiments presented herein relate to an audio system of a headset that characterizes a free field directivity pattern of near field acoustic transducer, decomposes the free field directivity pattern into a spherical harmonic (SH) representation of a given order and predicts an acoustic response at ears of a wearer of the headset from a weighted linear combination of the SH individual responses to the ear.

FIG. 6 illustrates an example graphical representation of a process 600 for individual transducer equalization that includes information about transducer directivity, in accordance with one or more embodiments. Steps of the process 600 (i.e., method) may be performed by one or more components of an audio system (e.g., the audio system 200). At step 602, the audio system may utilize an acoustic simulator 605 or an equalization prediction method (e.g., machine-learning based prediction) to characterize a transducer-to-ear response for an individual ear by representing a transducer by elementary SH sources 610 (e.g., monopole, dipole, quadrapole, etc.) At step 612, the audio system may generate individual ear pressure fields 615 (i.e., 615₁, 615₂, 615₃, . . . , 615_{N}) as a function of frequency. The steps 602 and 612 may be performed once for each individual ear and the individual ear pressure fields 615₁, 615₂, 615₃, . . . , 615_{N} may be compressed and stored (e.g., at a non-transitory storage medium of the audio system) for later user.

At step 622, the audio system may characterize a frequency-dependent directivity pattern 625 of the transducers in a free field and model the directivity pattern as a weighted linear combination of the elementary SH sources 610 (e.g., monopole, dipole, quadrapole, multipole). Considering DI(f) to represent the free-field frequency-dependent directivity pattern 625 (e.g., glasses transducer directivity pattern), then the following holds:

DI(f)=w₁(f)×monopole+w₂(f)×dipole+w₃(f)×quadrapole+ . . . +w_{N}(f)×multipole, (6)

where w₁(f), w₂(f), w₃(f), . . . w_{N}(f) are free-field frequency-dependent coefficients (weights) stored by the audio system (e.g., for a particular form factor). Eq. 6 may hold for various systems with different form factors, e.g., an eyeglass form factor, head-mounted display form factor, etc. The audio system may predict an individual acoustic response 635 (e.g., individual glasses-to ear acoustic response) by linearly combining weighted individual ear pressure fields 630₁, 630₂, . . . , 630_{N}.

In one embodiment, a free-field directivity of a test device may be characterized by a weighted sum of a monopole and a dipole, i.e., DI=w₁×monopole+w₂×dipole, where w₁ and w₂ are the SH coefficients (weights). The audio system characterizes the individual ear responses for each elementary SH source, in this case monopole and dipole. With that, the audio system obtains the frequency response (FR) of the i-th individual ear as:

FR(ear_i)=w₁×monopole(ear_i)+w₂×dipole(ear_i). (7)

In some embodiments, the process 600 comprises describing a transducer of a headset using a plurality of elementary SH sources 610. The process 600 generates individual ear pressure fields 615₁, 615₂, 615₃, . . . , 615_{N} as a function of frequency for each of the plurality of elementary SH sources 610 using an acoustic simulator 605, and determines a set of weights (w₁, w₂, w₃, . . . w_{N}) for the transducer on the headset, the set of weights including a respective weight for each of the plurality of SH sources 610. The process 600 determines the individual headset-to ear acoustic response 635 using the set of weights and the individual ear pressure fields 615₁, 615₂, 615₃, . . . , 615_{N}.

### Audio Apparatuses to Enhance Acoustic Properties of Audio System on Headset

Embodiments of the present disclosure are further related to an audio apparatus that can be mounted on one or both ear sides of a headset (i.e., eyewear device) for enhancing one or more acoustic properties of the headset. The enhanced acoustic properties may include: (i) increased acoustic power that an audio port of the headset emits and that reaches an entrance to an ear canal (“playback volume”); (ii) decreased acoustic power of sound sources in an environment that would have reached the entrance to the ear canal (“noise suppression”); (iii) decreased amount of acoustic power that the audio port emits that would have reached the environment (“audio leakage”), some other acoustic property, or some combination thereof. The audio apparatus may be accessory to the headset and may be removably coupled to the headset, such that when coupled to the headset the audio apparatus is proximate to and partially or fully encloses ears of the user.

FIG. 7A illustrates an example audio apparatus 700 that is removably coupled to a temple arm 705 of a headset 710, in accordance with one or more embodiments. The headset 710 may be an embodiment of the headset 100. The headset 710 may include an audio system for presenting audio content to a user. As such, the headset 710 may be implemented as an audio-enabled electronic glasses. The audio system may include at least one audio port 712 on each temple arm 705. The audio port 712 may be configured to present audio content to the user. In one or more embodiments (not shown in FIG. 7A), there are a plurality of audio ports on each temple arm 705. For example, each temple arm 705 may include a dipole speaker that outputs positive acoustic pressure waves via one or more positive audio ports and negative acoustic pressure waves via one or more negative audio ports. The audio ports on each template arm 705 may be positive audio ports, negative audio ports, or some combination thereof. For example, the audio system may include one or more dipole speakers on each temple arm that each include at least one positive audio port and at least one negative audio port.

In the embodiment shown in FIG. 7A, the audio apparatus 700 comprises a shell that fully encloses an ear of the user, and the shell may be removably coupled to the temple arm 705. In this embodiment, the audio apparatus 700, when coupled to the temple arm 705, forms an acoustic chamber 715 that fully encloses an entrance 717 to an ear canal and the audio port 712 on the temple arm 705. There may be one audio apparatus 700 for each ear of the user.

FIG. 7B illustrates an example side cross section 720 of the audio apparatus 700, in accordance with one or more embodiments. The audio apparatus 700 may direct sound waves 725 to the ear entrance 717 that would otherwise not be received at the ear entrance 717. FIG. 7B shows side cross section 720 that illustrates how the sound waves 725 emitted from the audio port 712 are reflected from a surface of the acoustic chamber 715 towards the ear entrance 717.

The re-direction of sound waves 725 via the acoustic chamber 715 may function to increase the playback volume. Furthermore, the audio apparatus 700 may separate sound sources in the environment from the ear entrance 717—thereby increasing noise suppression and reducing audio leakage.

The audio apparatus 700 may further include one or more controls that affect audio performance. The one or more controls may be, e.g., only on one audio apparatus 700 (e.g., left side or right side), same controls on each audio apparatus 700 (both left side and right side), or different controls on each audio apparatus 700. The one or more controls may allow the audio system and/or the user to achieve a set of target performance metrics for some or all of the acoustic properties. For example, one or both audio apparatuses 700 may include: a respective physical vent system that the user can open or close, fully or partially, an electronic system that can digitally adjust one or more of the acoustic properties, or some combination thereof

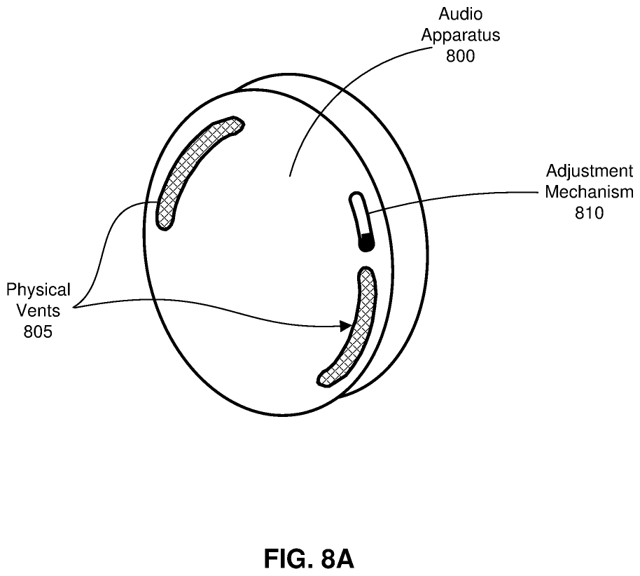

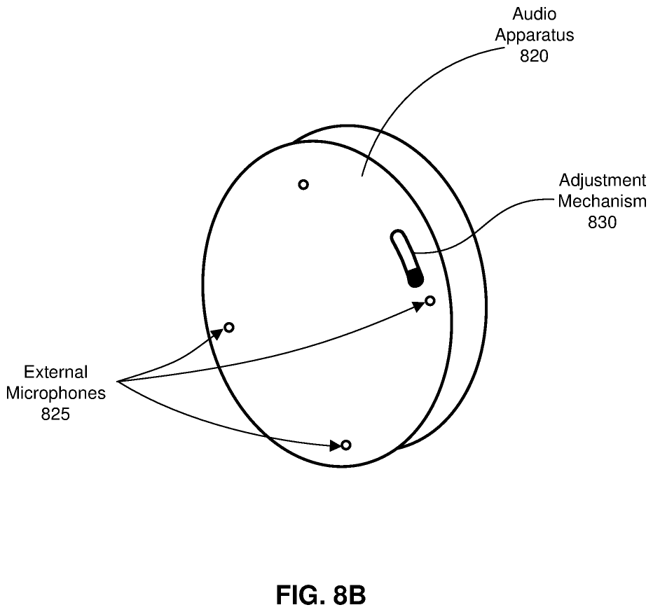

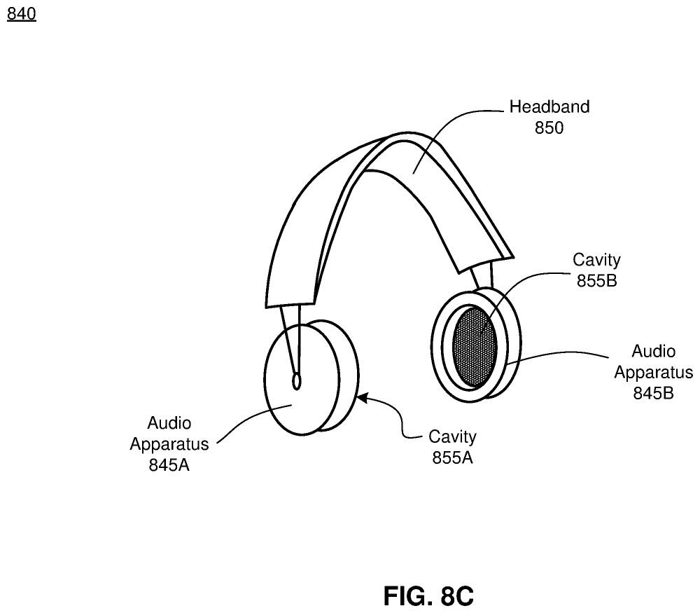

FIG. 8A illustrates an example audio apparatus 800 that includes a plurality of physical vents 805 and an adjustment mechanism 810, in accordance with one or more embodiments. The audio apparatus 800 may be an embodiment of the audio apparatus 700. The adjustment mechanism 810 may allow the user to control to what extent the physical vents 805 are open. For example, the adjustment mechanism 810 may fully close one or both physical vents 805, fully open one or both physical vents 805, and may partially open one or both physical vents 805.

Once the audio apparatus 800 is attached to an audio-enabled electronic glasses (e.g., the headset 710), the audio apparatus 800 may also incorporate additional controls for the audio-enabled electronic glasses. The additional controls at the audio apparatus 800 (not shown in FIG. 8A) may include volume controls, on-off controls, or other non-audio functions. The additional controls at the audio apparatus 800 may be gained by, e.g., physical mechanisms that connect mechanisms in the apparatus at the audio apparatus 800 with mechanisms in the audio-enabled electronic glasses, a wireless connection established by proximity of the apparatus at the apparatus audio 800 with the audio-enabled electronic glasses, or some combination thereof

FIG. 8B illustrates an example audio apparatus 820 that includes one or more external microphones 825 and an adjustment mechanism 830, in accordance with one or more embodiments. The audio apparatus 820 may be an embodiment of the audio apparatus 700 that is removable coupled to the temple arm 705 of the headset 710 in FIG. 7A. In some embodiments, the audio apparatus 820 may include the one or more external microphones 810, whereas the temple arm 705 may also include one or more microphones (not shown in FIG. 7A). At least some of the one or more microphones on the temple arm 705 may be enclosed within the audio apparatus 820 when the audio apparatus 820 is coupled to the temple arm 705. The audio system may also be able to perform active noise cancellation (ANC), and use the external microphones 825 for feedforward ANC and the one or more microphones on the temple arm 705 that are enclosed by the audio apparatus 820 for feedback ANC. The adjustment mechanism 830 may allow the user to control to what extent the external microphones 825 are open. For example, the adjustment mechanism 830 may fully close at least one of the external microphones 825, fully open at least one of the external microphones 825, and may partially open at least one of the external microphones 825.

FIG. 8C illustrates an example 840 of a pair of audio apparatuses 845A, 845B coupled to each other via a headband 850, in accordance with one or more embodiments. Each of the audio apparatuses 845A, 845B may be an embodiment of the audio apparatus 800 in FIG. 8A or the audio apparatus 820 in FIG. 8B. A user may wear both the audio-enabled electronic glasses (e.g., the headset 710) and the audio apparatuses 845A, 845B coupled via the headband 850. Each of the audio apparatuses 845A, 845B may include a respective single cavity 855A, 855B, which may house an audio port and an ear entrance.

FIG. 9 illustrates an example audio apparatus 900 for enhancing acoustic features of an audio system that partially encloses a user's ear, in accordance with one or more embodiments. The audio apparatus 900 may be coupled to a temple arm 905 of a headset (i.e., eyewear device) that includes the audio system. The audio apparatus 900 may be removably coupled to the temple arm 905 in a manner that covers some or all of positive audio ports of the headset, and in some cases may also cover some or all of negative audio ports of the headset. The temple arm 905 may include a speaker 907 (e.g., a dipole speaker) that is internal to the temple arm 905, a rear port 910 (i.e., a negative audio port), and a front port 912 (i.e., a positive audio port). The speaker 907 may vent negative acoustic pressure waves via the rear port 910 and positive acoustic pressure waves via the front port 912.

The audio apparatus 900 may include an audio waveguide 915 with an extended front port 917 that is proximate to an ear entrance 920 of (i.e., entrance to an ear canal of the user's ear). The audio apparatus 900 couples to the temple arm 905 in a manner such that the front port 912 may emit the positive acoustic pressure waves into the audio waveguide 915. The audio waveguide 915 may direct and emit the positive acoustic pressure waves towards the extended front port 917. The extended front port 917 may further vent the positive acoustic pressure waves to the ear entrance 920 and into the ear canal. Thus, the audio waveguide 915 moves an effective location of the covered positive audio ports (e.g., the front port 912 at the temple arm 905) to a location proximate to the ear entrance 920 (e.g., to the extended front port 917), thereby enhancing at least one acoustic property of the headset. The extended front port 917 may be extended relative to the front port 912 by, e.g., approximately 20 mm. In some embodiments (not shown in FIG. 9), the audio apparatus 900 includes at least one microphone near the ear entrance 920 that may be used for ANC by the audio system. The benefit of the presented configuration of the audio system and the audio apparatus 900 is to significantly increase efficiency of the audio system, as well as to maximize a sound pressure level at the ear entrance 920. Since the audio system becomes more efficient, the speaker 907 needs to work less to achieve a target level of sound pressure at the ear entrance 920. Hence, leakage of the speaker 907 is also reduced.

### Process Flow

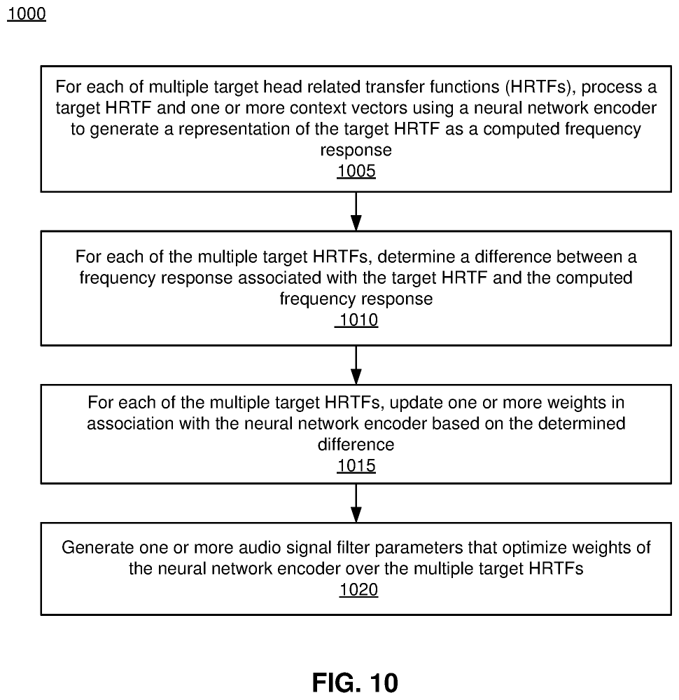

FIG. 10 is a flowchart illustrating a process 1000 for generating parameterized HRTFs for rendering audio content to users, in accordance with one or more embodiments. The process 1000 shown in FIG. 10 may be performed by components of an audio system (e.g., components of the audio system 200 and/or components shown in FIGS. 3-4 and FIG. 6). Other entities may perform some or all of the steps in FIG. 10 in other embodiments. Embodiments may include different and/or additional steps, or perform the steps in different orders.

The audio system processes 1005, for each of multiple target HRTFs, a target HRTF and one or more context vectors using a neural network encoder (e.g., the neural network encoder 310) to generate a representation of the target HRTF as a computed frequency response. The one or more context vectors may include information about a spatial location at which the target HRTF is measured, and one or more anthropometric features values of a user associated with the target HRTF. The representation of the target HRTF may comprise information about a gain, a center frequency, and a Q factor of a set of biquad filters arranged in a filter cascade. The computed frequency response may be a frequency response of the filter cascade.

The audio system determines 1010 (e.g., via the audio controller 230 or the differentiable decoder 320), for each of the target HRTFs, a difference between a frequency response associated with the target HRTF and the computed frequency response. The audio system updates 1015 (e.g., via the audio controller 230 or the neural network encoder 310), for each of the target HRTFs, one or more weights in association with the neural network encoder based on the determined difference.

The audio system generates 1020 (e.g., via the audio controller 230 or the neural network encoder 310) one or more audio signal filter parameters that optimize weights of the neural network encoder over the multiple target HRTFs. The audio system may render (e.g., via the audio controller 230) an audio signal using the one or more audio signal filter parameters to generate a rendered version of the audio signal for presentation to one or more users. The audio system may present (e.g., via the transducer array 210) the rendered version of the audio signal to the one or more users.

In some embodiments, the audio system (e.g., the audio system 200 or the audio system comprising the hearing assistance device 400) applies a hearing aid processing to an audio signal to generate an altered signal. The hearing aid processing may comprise a time-varying and frequency-dependent processing. In such cases, the audio system may further apply an adaptive filter to the altered signal to generate a filtered version of the altered signal. The adaptive filter may comprise a time-varying and frequency-dependent filter. The audio system may spatialize the altered signal using a fixed HRTF to generate a spatialized version of the altered signal. The fixed HRTF may comprise a frequency-dependent HRTF. The audio system may combine the filtered version of the altered signal and the spatialized version of the altered signal to generate audio content for presentation to a user, wherein the audio content may comprise a spatialized aided version of the audio signal. The audio system may present to the user (e.g., via the transducer array 210) the generated audio content with the spatialized aided version of the audio signal.

In some embodiments, a transducer of a headset (e.g., a transducer of the transducer array 210) is described using a plurality of elementary SH sources. In such cases, the audio system (e.g., the audio system 200) may generate individual ear pressure fields as a function of frequency for each of the plurality of elementary SH sources using an acoustic simulator. The audio system may further determine a set of weights for the transducer on the headset, the set of weights including a respective weight for each of the plurality of SH sources. After that, the audio system may determine an individual headset-to ear acoustic response using the set of weights and the individual ear pressure fields. The audio system may generate weighted individual ear pressure fields by weighting individual ear pressure fields using the set of weights. The audio system may linearly combine the weighted individual ear pressure fields to determine the individual headset-to ear acoustic response. The audio system may render an audio signal using the individual headset-to ear acoustic response to generate a rendered version of the audio signal for presentation to a user. The audio system may present (e.g., via the transducer array 210) the rendered version of the audio signal to the user.

### System Environment

FIG. 11 is a system 1100 that includes a headset 1105, in accordance with one or more embodiments. In some embodiments, the headset 1105 may be the headset 100 of FIG. 1A or the headset 105 of FIG. 1B. The system 1100 may operate in an artificial reality environment (e.g., a virtual reality environment, an augmented reality environment, a mixed reality environment, or some combination thereof). The system 1100 shown by FIG. 11 includes the headset 1105, an input/output (I/O) interface 1110 that is coupled to a console 1115, the network 1120, and the mapping server 1125. While FIG. 11 shows an example system 1100 including one headset 1105 and one I/O interface 1110, in other embodiments any number of these components may be included in the system 1100. For example, there may be multiple headsets each having an associated I/O interface 1110, with each headset and I/O interface 1110 communicating with the console 1115. In alternative configurations, different and/or additional components may be included in the system 1100. Additionally, functionality described in conjunction with one or more of the components shown in FIG. 11 may be distributed among the components in a different manner than described in conjunction with FIG. 11 in some embodiments. For example, some or all of the functionality of the console 1115 may be provided by the headset 1105.

The headset 1105 includes the display assembly 1130, an optics block 1135, one or more position sensors 1140, and the DCA 1145. Some embodiments of headset 1105 have different components than those described in conjunction with FIG. 11. Additionally, the functionality provided by various components described in conjunction with FIG. 11 may be differently distributed among the components of the headset 1105 in other embodiments, or be captured in separate assemblies remote from the headset 1105.

The display assembly 1130 displays content to the user in accordance with data received from the console 1115. The display assembly 1130 displays the content using one or more display elements (e.g., the display elements 120). A display element may be, e.g., an electronic display. In various embodiments, the display assembly 1130 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 1135.

The optics block 1135 may magnify image light received from the electronic display, corrects optical errors associated with the image light, and presents the corrected image light to one or both eye boxes of the headset 1105. In various embodiments, the optics block 1135 includes one or more optical elements. Example optical elements included in the optics block 1135 include: an aperture, a Fresnel lens, a convex lens, a concave lens, a filter, a reflecting surface, or any other suitable optical element that affects image light. Moreover, the optics block 1135 may include combinations of different optical elements. In some embodiments, one or more of the optical elements in the optics block 1135 may have one or more coatings, such as partially reflective or anti-reflective coatings.

Magnification and focusing of the image light by the optics block 1135 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 1135 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 1135 corrects the distortion when it receives image light from the electronic display generated based on the content.

The position sensor 1140 is an electronic device that generates data indicating a position of the headset 1105. The position sensor 1140 generates one or more measurement signals in response to motion of the headset 1105. The position sensor 190 is an embodiment of the position sensor 1140. Examples of a position sensor 1140 include: one or more IMUs, one or more accelerometers, one or more gyroscopes, one or more magnetometers, another suitable type of sensor that detects motion, or some combination thereof. The position sensor 1140 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 1105 from the sampled data. For example, the IMU integrates the measurement signals received from the accelerometers over time to estimate a velocity vector and integrates the velocity vector over time to determine an estimated position of a reference point on the headset 1105. The reference point is a point that may be used to describe the position of the headset 1105. While the reference point may generally be defined as a point in space, however, in practice the reference point is defined as a point within the headset 1105.

The DCA 1145 generates depth information for a portion of the local area. The DCA includes one or more imaging devices and a DCA controller. The DCA 1145 may also include an illuminator. Operation and structure of the DCA 1145 is described above with regard to FIG. 1A.

The audio system 1150 provides audio content to a user of the headset 1105. The audio system 1150 is substantially the same as the audio system 200 described above. The audio system 1150 may comprise one or acoustic sensors, one or more transducers, and an audio controller. The audio system 1150 may provide spatialized audio content to the user. In some embodiments, the audio system 1150 may request acoustic parameters from the mapping server 1125 over the network 1120. The acoustic parameters describe one or more acoustic properties (e.g., room impulse response, a reverberation time, a reverberation level, etc.) of the local area. The audio system 1150 may provide information describing at least a portion of the local area from e.g., the DCA 1145 and/or location information for the headset 1105 from the position sensor 1140. The audio system 1150 may generate one or more sound filters using one or more of the acoustic parameters received from the mapping server 1125, and use the sound filters to provide audio content to the user.

In accordance with embodiments of the present disclosure, the audio system 1150 generates parameterized HRTFs for rendering audio content to different users. In such case, the audio system 1150 may process, for each of multiple HRTFs, a target HRTF and one or more context vectors using a neural network encoder to generate a representation of the target HRTF as a computed frequency response, determine, for each of the multiple HRTFs, a difference between a frequency response associated with the target HRTF and the computed frequency response, update, for each of the multiple HRTFs, one or more weights in association with the neural network encoder based on the determined difference, and generate one or more audio signal filter parameters that optimize weights of the neural network encoder over the multiple target HRTFs.

The audio system 1150 may further perform an adaptive hearing enhancement. In such case, the audio system 1150 may apply a hearing aid processing to an audio signal to generate an altered signal, apply an adaptive filter to the altered signal to generate a filtered version of the altered signal, spatialize the altered signal using a fixed HRTF to generate a spatialized version of the altered signal, and combine the filtered version of the altered signal and the spatialized version of the altered signal to generate audio content for presentation to a user, the audio content comprising a spatialized aided version of the audio signal.

The audio system 1150 may further perform individual transducer equalization that includes transducer directivity. In such case, a transducer of the audio system 1150 may be described using a plurality of elementary SH sources. The audio system 1150 may generate individual ear pressure fields as a function of frequency for each of the plurality of elementary SH sources using an acoustic simulator, determine a set of weights for the transducer on the headset, the set of weights including a respective weight for each of the plurality of SH sources, and determine an individual headset-to ear acoustic response using the set of weights and the individual ear pressure fields.

In some embodiments, the headset 1105 is configured for enhancing acoustic properties of the audio system 1150. The audio system 1150 may include a port on a temple arm of the headset 1105 that is configured to present audio content to a user of the headset 1105. The headset 1105 may comprise an audio apparatus that is removably coupled to the temple arm. The audio apparatus may include at least one control that affects audio performance of the audio system 1150. The audio apparatus functions to enhance at least one acoustic property of the headset 1105.

In some embodiments, the audio system 1150 is part of an IED for presenting audio content to a user of the headset 1105. The IED may comprise a body configured to fit at least partially within an ear canal, an IMU within the body configured to provide IMU data, a camera coupled to the body and positioned to capture images outside of the ear canal, a controller, and a transducer within the body. The controller of the IED may determine positions of the IED using the IMU data, the positions including a drift error, adjust the positions to remove the drift error, the adjustment based in part on positions of the IED determined using the captured images, and generate audio content based in part on the adjusted positions. The transducer of the IED may present the audio content to the user of the headset 1105.

The I/O interface 1110 is a device that allows a user to send action requests and receive responses from the console 1115. An action request is a request to perform a particular action. For example, an action request may be an instruction to start or end capture of image or video data, or an instruction to perform a particular action within an application. The I/O interface 1110 may include one or more input devices. Example input devices include: a keyboard, a mouse, a game controller, or any other suitable device for receiving action requests and communicating the action requests to the console 1115. An action request received by the I/O interface 1110 is communicated to the console 1115, which performs an action corresponding to the action request. In some embodiments, the I/O interface 1110 includes an IMU that captures calibration data indicating an estimated position of the I/O interface 1110 relative to an initial position of the I/O interface 1110. In some embodiments, the I/O interface 1110 may provide haptic feedback to the user in accordance with instructions received from the console 1115. For example, haptic feedback is provided when an action request is received, or the console 1115 communicates instructions to the I/O interface 1110 causing the I/O interface 1110 to generate haptic feedback when the console 1115 performs an action.

The console 1115 provides content to the headset 1105 for processing in accordance with information received from one or more of: the DCA 1145, the headset 1105, and the I/O interface 1110. In the example shown in FIG. 11, the console 1115 includes an application store 1155, a tracking module 1160, and an engine 1165. Some embodiments of the console 1115 have different modules or components than those described in conjunction with FIG. 11. Similarly, the functions further described below may be distributed among components of the console 1115 in a different manner than described in conjunction with FIG. 11. In some embodiments, the functionality discussed herein with respect to the console 1115 may be implemented in the headset 1105, or a remote system.

The application store 1155 stores one or more applications for execution by the console 1115. An application is a group of instructions, that when executed by a processor, generates content for presentation to the user. Content generated by an application may be in response to inputs received from the user via movement of the headset 1105 or the I/O interface 1110. Examples of applications include: gaming applications, conferencing applications, video playback applications, or other suitable applications.

The tracking module 1160 tracks movements of the headset 1105 or of the I/O interface 1110 using information from the DCA 1145, the one or more position sensors 1140, or some combination thereof. For example, the tracking module 1160 determines a position of a reference point of the headset 1105 in a mapping of a local area based on information from the headset 1105. The tracking module 1160 may also determine positions of an object or virtual object. Additionally, in some embodiments, the tracking module 1160 may use portions of data indicating a position of the headset 1105 from the position sensor 1140 as well as representations of the local area from the DCA 1145 to predict a future location of the headset 1105. The tracking module 1160 provides the estimated or predicted future position of the headset 1105 or the I/O interface 1110 to the engine 1165.

The engine 1165 executes applications and receives position information, acceleration information, velocity information, predicted future positions, or some combination thereof, of the headset 1105 from the tracking module 1160. Based on the received information, the engine 1165 determines content to provide to the headset 1105 for presentation to the user. For example, if the received information indicates that the user has looked to the left, the engine 1165 generates content for the headset 1105 that mirrors the user's movement in a virtual local area or in a local area augmenting the local area with additional content. Additionally, the engine 1165 performs an action within an application executing on the console 1115 in response to an action request received from the I/O interface 1110 and provides feedback to the user that the action was performed. The provided feedback may be visual or audible feedback via the headset 1105 or haptic feedback via the I/O interface 1110.

The network 1120 couples the headset 1105 and/or the console 1115 to the mapping server 1125. The network 1120 may include any combination of local area and/or wide area networks using both wireless and/or wired communication systems. For example, the network 1120 may include the Internet, as well as mobile telephone networks. In one embodiment, the network 1120 uses standard communications technologies and/or protocols. Hence, the network 1120 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 1120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1120 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 1125 may include a database that stores a virtual model describing a plurality of spaces, wherein one location in the virtual model corresponds to a current configuration of a local area of the headset 1105. The mapping server 1125 receives, from the headset 1105 via the network 1120, information describing at least a portion of the local area and/or location information for the local area. The user may adjust privacy settings to allow or prevent the headset 1105 from transmitting information to the mapping server 1125. The mapping server 1125 determines, based on the received information and/or location information, a location in the virtual model that is associated with the local area of the headset 1105. The mapping server 1125 determines (e.g., retrieves) one or more acoustic parameters associated with the local area, based in part on the determined location in the virtual model and any acoustic parameters associated with the determined location. The mapping server 1125 may transmit the location of the local area and any values of acoustic parameters associated with the local area to the headset 1105.

The HRTF optimization system 1170 for HRTF rendering may utilize neural networks to fit a large database of measured HRTFs obtained from a population of users with parametric filters. The filters are determined in such a way that the filter parameters vary smoothly across space and behave analogously across different users. The fitting method relies on a neural network encoder, a differentiable decoder that utilizes digital signal processing solutions, and performing an optimization of the weights of the neural network encoder using loss functions to generate one or more models of filter parameters that fit across the database of HRTFs. The HRTF optimization system 1170 may provide the filter parameter models periodically, or upon request to the audio system 1150 for use in generating spatialized audio content for presentation to a user of the headset 1105. In some embodiments, the provided filter parameter models are stored in the data store of the audio system 1150.

One or more components of system 1100 may contain a privacy module that stores one or more privacy settings for user data elements. The user data elements describe the user or the headset 1105. For example, the user data elements may describe a physical characteristic of the user, an action performed by the user, a location of the user of the headset 1105, a location of the headset 1105, HRTFs for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 1100 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
for each of multiple target head related transfer functions (HRTFs),
processing a target HRTF and one or more context vectors using a neural network encoder to generate a representation of the target HRTF as a computed frequency response,
determining a difference between a frequency response associated with the target HRTF and the computed frequency response, and
updating one or more weights in association with the neural network encoder based on the determined difference; and
generating one or more audio signal filter parameters that optimize weights of the neural network encoder over the multiple HRTFs.

2. The method of claim 1, wherein the one or more context vectors include information about a spatial location at which the target HRTF is measured, and one or more anthropometric features values of a user associated with the target HRTF.

3. The method of claim 1, wherein:
the representation of the target HRTF comprises information about a gain, a center frequency, and a Q factor of a set of biquad filters arranged in a filter cascade; and
the computed frequency response is a frequency response of the filter cascade.

4. The method of claim 1, further comprising:
rendering an audio signal using the one or more audio signal filter parameters to generate a rendered version of the audio signal for presentation to one or more users.

5. The method of claim 1, further comprising:
applying a hearing aid processing to an audio signal to generate an altered signal;
applying an adaptive filter to the altered signal to generate a filtered version of the altered signal;
spatializing the altered signal using a fixed HRTF to generate a spatialized version of the altered signal; and
combining the filtered version of the altered signal and the spatialized version of the altered signal to generate audio content for presentation to a user, the audio content comprising a spatialized aided version of the audio signal.

6. The method of claim 5, wherein:
the hearing aid processing comprises a time-varying and frequency-dependent processing;
the adaptive filter comprises a time-varying and frequency-dependent filter; and
the fixed HRTF comprises a frequency-dependent HRTF.

7. The method of claim 1, further comprising:
describing a transducer of a headset using a plurality of elementary spherical harmonic (SH) sources;
generating individual ear pressure fields as a function of frequency for each of the plurality of elementary SH sources using an acoustic simulator;
determining a set of weights for the transducer on the headset, the set of weights including a respective weight for each of the plurality of SH sources; and
determining an individual headset-to ear acoustic response using the set of weights and the individual ear pressure fields.

8. The method of claim 7, further comprising:
generating weighted individual ear pressure fields by weighting individual ear pressure fields using the set of weights; and
linearly combining the weighted individual ear pressure fields to determine the individual headset-to ear acoustic response.

9. The method of claim 7, further comprising:
rendering an audio signal using the individual headset-to ear acoustic response to generate a rendered version of the audio signal for presentation to a user.

10. An in-ear device (TED) comprising:
a body configured to fit at least partially within an ear canal;
an inertial measurement unit (IMU) within the body, the IMU configured to provide IMU data;
a camera coupled to the body, the camera positioned to capture images outside of the ear canal;
a controller configured to:
determine positions of the IED using the IMU data, the positions including a drift error,
adjust the positions to remove the drift error, the adjustment based in part on positions of the IED determined using the captured images, and
generate audio content based in part on the adjusted positions; and
a transducer within the body, the transducer configured to present the audio content.

11. The IED of claim 10, wherein the controller is further configured to:
determine depth information using the captured images; and
adjust the positions based at least in part on the determined depth information.

12. The IED of claim 10, wherein a data rate of the IMU is faster than a data rate of the camera.

13. The IED of claim 10, wherein the drift error accumulates between image frames of the captured images, and the controller is further configured to correct for the drift error at each image frame.

14. The IED of claim 10, wherein the controller is further configured to:
generate one or more audio filters using the adjusted positions; and
apply the one or more audio filters to an audio signal to generate the audio content for presentation to a user.

15. A system, comprising:
a headset including an audio system, the audio system including at least one audio port on a temple arm of the headset that is configured to present audio content to a user of the headset; and
an audio apparatus that is removably coupled to the temple arm, the audio apparatus including at least one control that affects audio performance of the system, wherein the audio apparatus functions to enhance at least one acoustic property of the headset.

16. The system of claim 15, wherein the audio apparatus is positioned proximate to an entrance of an ear of the user and encloses the ear and the at least one audio port.

17. The system of claim 15, wherein the at least one control comprises a plurality of physical vents configured by the user to be fully open, fully closed, partially open, or partially closed.

18. The system of claim 15, wherein the at least one control comprises an adjustment mechanism configured to adjust the at least one acoustic property.

19. The system of claim 15, wherein the audio apparatus comprises an audio waveguide that moves an effective location of the at least one audio port to a location proximate to an entrance of an ear of the user for enhancing the at least one acoustic property of the headset.

20. The system of claim 19, wherein the audio apparatus couples to the temple arm in a manner such that the at least one audio port emits acoustic pressure waves into the audio waveguide, and the audio waveguide directs and emits the acoustic pressure waves via an extended audio port of the audio apparatus that is proximate to an entrance of an ear of the user.
